(19) United States
(12) Patent Application Publication
(10) Pub. No.: US 2011/0146883 A1
(43) Pub. Date: Jun. 23, 2011

(54) CONTINUOUS MIXING SYSTEM AND APPARATUS

(76) Inventor: Gary Robert Burg, Massillon, OH (US)

(21) Appl. No.: 12/950,190

(22) Filed: Nov. 19, 2010

Related U.S. Application Data
(60) Provisional application No. 61/289,630, filed on Dec. 23, 2009.

(51) Int. Cl. B29C 47/30; B29C 47/50

(52) U.S. Cl. 156/110.1; 366/76.4

(57) ABSTRACT

An apparatus for applying a mixtures of a first compound and a second compound, the apparatus comprising: a first extruder and a first gear pump for a first compound; a second extruder and a second gear pump for a second compound, a third extruder and a third gear pump for an accelerator mixture; a mixing device for mixing together said first compound and said second compound and said accelerator mixture, wherein said mixing device is located downstream of said first, second and third extruders and said first, second and third gear pumps.

### CROSS REFERENCE TO OTHER APPLICATIONS

This application claims the benefit of and incorporates by reference U.S. Provisional Application No. 61/289,630 filed Dec. 23, 2009.

### FIELD OF THE INVENTION

The invention relates in general to tire manufacturing, and more particularly to continuous production of custom rubber mixtures.

### BACKGROUND OF THE INVENTION

Tire manufacturers have progressed to more complicated designs due to an advance in technology as well as a highly competitive industrial environment. In particular, tire designers seek to use multiple rubber compounds in a tire in order to meet customer demands. Using multiple rubber compounds per tire can result in a huge number of compounds needed to be on hand for the various tire lines of the manufacturer. For cost and efficiency reasons, tire manufacturers seek to limit the number of compounds available due to the extensive costs associated with each compound. Each compound typically requires the use of a banbury mixer, which involves expensive capital expenditures. Furthermore, banbury mixers have difficulty mixing up tough or stiff rubber compounds. The compounds generated from the banbury mixers are typically shipped to the tire building plants, thus requiring additional costs for transportation. The shelf life of the compounds is not finite, and if not used within a certain time period, is scrapped.

Thus an improved method and apparatus is desired which substantially reduces the need for the use of banbury mixers while providing an apparatus and methodology to provide for custom mixing at the tire building machine by blending of two or more compounds together, and controlling the ratio of the compounds and other additives. Both non-productive compounds and/or productive compounds could be blended together. It is further desired to have a system at the tire building machine which provides for the ability to manufacture customizable compounds with curing accelerators. Yet an additional problem to be solved is to generate the compounds continuously at the tire building machine.

### SUMMARY OF THE INVENTION

The invention provides in a first aspect an apparatus for applying mixtures of a first compound and a second compound, the apparatus comprising: a first extruder and a first gear pump for a first compound; a second extruder and a second gear pump for a second compound, a third extruder and a third gear pump for an accelerator mixture; and a mixing device for mixing together said first compound and said second compound and said accelerator mixture, wherein said mixing device is located downstream of said first, second and third extruders and said first, second and third gear pumps.

### DEFINITIONS

“Aspect Ratio” means the ratio of a tire's section height to its section width.

“Axial” and “axially” means the lines or directions that are parallel to the axis of rotation of the tire.

“Bead” or “Bead Core” means generally that part of the tire comprising an annular tensile member, the radially inner beads are associated with holding the tire to the rim being wrapped by ply cords and shaped, with or without other reinforcement elements such as flippers, chippers, apexes or fillers, toe guards and chafers.

“Belt Structure” or “Reinforcing Belts” means at least two annular layers or plies of parallel cords, woven or unwoven, underlying the tread, unanchored to the bead, and having both left and right cord angles in the range from 17° to 27° with respect to the equatorial plane of the tire.

“Bias Ply Tire” means that the reinforcing cords in the carcass ply extend diagonally across the tire from bead-to-bead at about 25-65° angle with respect to the equatorial plane of the tire, the ply cords running at opposite angles in alternate layers

“Breakers” or “Tire Breakers” means the same as belt or belt structure or reinforcement belts.

“Carcass” means a laminate of tire ply material and other tire components cut to length suitable for splicing, or already spliced, into a cylindrical or toroidal shape. Additional components may be added to the carcass prior to its being vulcanized to create the molded tire.

“Circumferential” means lines or directions extending along the perimeter of the surface of the annular tread perpendicular to the axial direction; it can also refer to the direction of the sets of adjacent circular curves whose radii define the axial curvature of the tread as viewed in cross section.

“Cord” means one of the reinforcement strands, including fibers, which are used to reinforce the plies.

“Inner Liner” means the layer or layers of elastomer or other material that form the inside surface of a tubeless tire and that contain the inflating fluid within the tire.

“Inserts” means the reinforcement typically used to reinforce the sidewalls of runflat-type tires; it also refers to the elastomeric insert that underlies the tread.

“Ply” means a cord-reinforced layer of elastomer-coated, radially deployed or otherwise parallel cords.

“Radial” and “radially” mean directions radially toward or away from the axis of rotation of the tire.

“Radial Ply Structure” means the one or more carcass plies or which at least one ply has reinforcing cords oriented at an angle of between 65° and 90° with respect to the equatorial plane of the tire.

“Radial Ply Tire” means a belted or circumferentially-restricted pneumatic tire in which the ply cords which extend from bead to bead are laid at cord angles between 65° and 90° with respect to the equatorial plane of the tire.

“Sidewall” means a portion of a tire between the tread and the bead.

“Laminate structure” means an unvulcanized structure made of one or more layers of tire or elastomer components such as the innerliner, sidewalls, and optional ply layer.

“Productive compound” means a rubber compound that includes accelerators, sulfur and other materials needed to cure the rubber.

“Non-productive compound” means a rubber compound that does not have one or more of the following items: 1) accelerator; 2) sulfur; or 3) curing agent(s).

### BRIEF DESCRIPTION OF THE DRAWINGS

The invention will be described by way of example and with reference to the accompanying drawings in which:

FIG. 1 is a schematic of a mixing system of the present invention; and

FIG. 2 is a schematic of a second embodiment of the present invention.

### DETAILED DESCRIPTION OF THE INVENTION

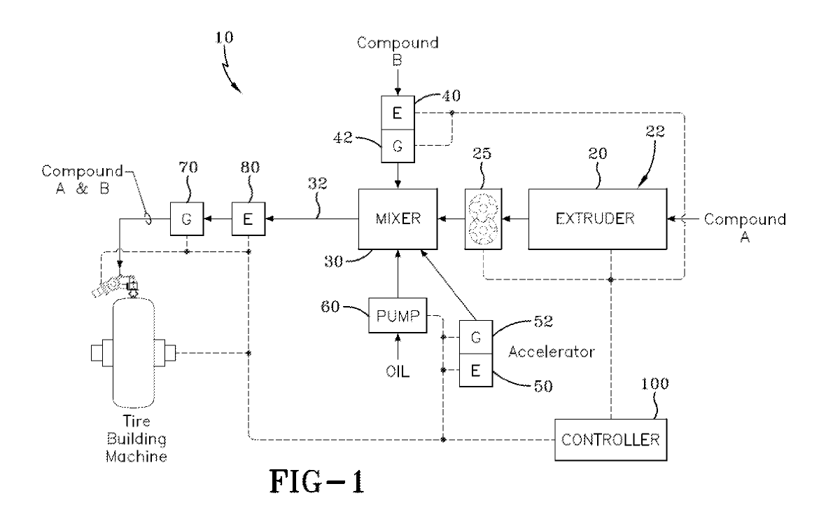

FIG. 1 illustrates a first embodiment of a method and apparatus 10 for a continuous mixing system suitable for use for making rubber compositions for tires or tire components. The continuous mixing system is not limited to tire applications and may be used for example, to make other rubber components not related to tires such as conveyors, hoses, belts, etc. The mixing system may be provided directly at the tire building machinery for direct application of the rubber composition to a tire building drum or other tire building apparatus. As shown in FIG. 1, a continuous mixing apparatus 10 is shown and which includes an extruder 20. The extruder 20 has an inlet 22 for receiving a first compound A, which may be a productive or non-productive rubber composition. The extruder may comprise any commercial extruder suitable for processing of rubber or elastomer compounds. The extruder may comprise a commercially available extruder commonly known by those skilled in the art as a pin type extruder, a twin screw, a ring extruder or a single screw extruder. One commercially available extruder suitable for use is a multicut transfermix (MCT) extruder, sold by VMI-AZ GmbH, The Netherlands. Preferably, the extruder has an L/D of about 8, but may range from about 5 to about 25. A pin type or MCT type of extruder, or combination thereof, is preferred, but is not limited to same.

The extruder functions to warm up the compound A to the temperature in the range of about 80° C. to about 150° C., preferably about 90° C. to about 120° C., and to masticate the rubber composition as needed. Compound A exits the extruder and is fed into an optional gear pump 25. The optional gear pump 25 functions as a metering device and a pump. The gear pump may have gears such as planetary gears, bevel gears or other gears. Output from the gear pump 25 is fed into a mixing or blending chamber 30. The mixing chamber may be any commercial mixing device such as a MCTD sold by VMI, or a static mixer. As compound A is fed into the mixing chamber, it is mixed with compound B.

Compound B may also comprise a productive or non-productive rubber composition. Examples of compound B compositions are described in more detail, below. Compound B is first extruded by extruder 40 and gear pump 42 prior to entering the mixing chamber 30. The extruder 40 may be a conventional pin type, ring type, dual screw or single screw type extruder. The gear pump 42 functions as a metering device and a pump and may have gears such as planetary gears, bevel gears or other gears. The extruder 40 and gear pump 42 may also be a combination unit.

Oil may be optionally injected into the mixer via an oil pump 60. The oil controls the viscosity of the compound mixture in the mixing chambers. The apparatus may further include one or more accelerators which may be optionally added to the mixing chamber 30 via a gear pump 52 (or combination thereof). If more than one accelerator is used, they may be added into the mixing chamber 30 separately or together. For example, a primary accelerator and a secondary accelerator may both be added. Accelerators are used to control the time and/or temperature required for vulcanization and to improve the properties of the rubber. The accelerator may be in powder form or an encapsulated powder into a resin or rubber base. Examples of accelerator compositions are described in more detail, below.

A curative agent or precursor may also be added to the mixer via mechanical means such as a gear pump or extruder or pump or combination thereof. The mechanical device selected depends upon the phase of the curative agent. One example of a curative agent is sulfur. The sulfur may be added in liquid or solid form.

Thus the apparatus of the invention produces a third compound C which is a precise mixture of the A and B compound, optional oil and optional accelerant and optional curative agent or precursor. The ratio of the volumetric flow rate of compound A to the volumetric flow rate of compound B is precisely controlled by the ratio of the speed of the gear pump 25 for compound A and the speed of gear pump 42 for compound B. For example, the compound output 32 from the system mixer may comprise a mixture of 20% of compound A and 80% of compound B by volume. Alternatively, the compound output from the system may comprise a mixture of 20% of compound B and 80% of compound A by volume. The ratio of compound A to compound B can range from 0:100% to 100%:0. The ratio may be adjusted instantaneously by varying the speeds of gear pumps 25 and 42 by a computer controller 100. The computer controller 100 may additionally controls the extruder and gear pump operating parameters such as operating pressure, operating temperature, pump or screw speed.

Preferably, the computer controller 100 sets a pressure target value for the exit pressure of each extruder. The extruder speed is controlled by the controller, and is varied until the pressure target is met. The extruder exit pressure target value affects the quality of mixing by causing backflow of the material in the extruder.

The compound mixture of A and B exits the mixer 30, and enters gear pump 70. The apparatus 10 is preferably located at or near a tire building station. Gear pump 70 preferably applies the compound formulation output from the mixer exit directly onto the tire building machine. The tire building machine may be a tire building drum or core. An optional extruder 80 may be used upstream of gear pump 70 or in combination thereof.

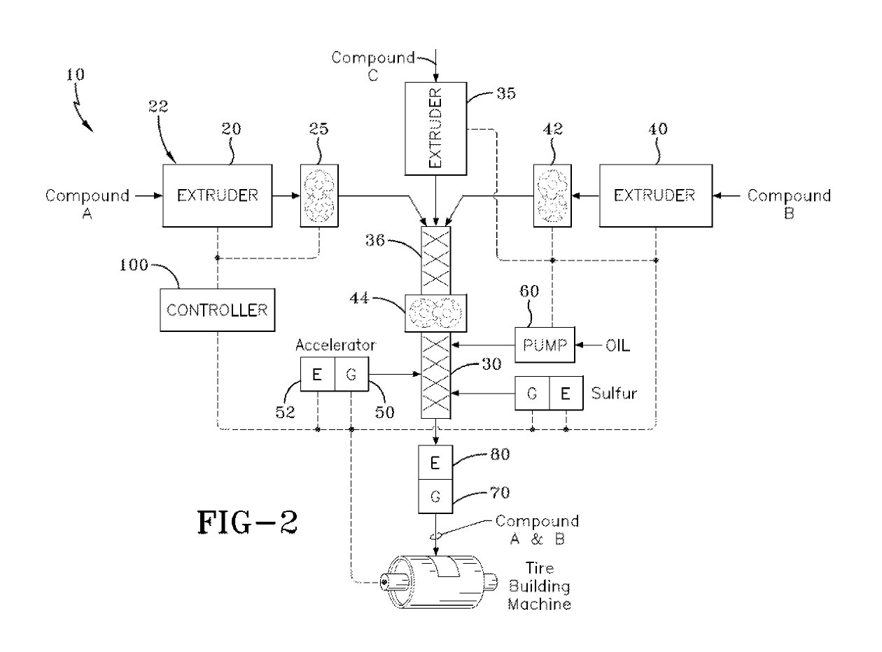

FIG. 2 illustrates a second embodiment of the invention. Compound A enters extruder 20 at inlet 22 and is then fed into optional gear pump 25. Compound B is fed into extruder 40 and then into gear pump 42. Optional compound C may be added with compound A and B into a first mixer 36 via optional extruder 35. Compound A and compound B and optionally compound C are then fed into a first mixer 36 where they are mixed together. The first mixer 36 may be a static or dynamic mixing device. The compound mixture of A+B exits the mixing chamber and is pumped by an optional gear pump 44. The compound mixture of A, B and optionally C is then fed into a second mixer 30, which may be static or dynamic. Oil may be added to the compound mixture of A+B via pump 60. Optionally, sulfur and one or more accelerants may be added to the A+B mixture via a gear pump or other mechanical device.

Optionally, an accelerator may be added to the final mixture just upstream of the gear pump extruder 70, 80.

The final mixture exits the mixing chamber and is fed into an extruder gear pump 70, 80 which is located at the tire building machine. The final compound mixture may be extruded directly onto the tire building machine in one or more strips to form the tire component as desired.

### I. Accelerator Compositions

In one embodiment, a single accelerator system may be used, i.e., primary accelerator. The primary accelerator(s) may be used in total amounts ranging from about 0.5 to about 4, alternatively about 0.8 to about 1.5, phr. In another embodiment, combinations of a primary and a secondary accelerator might be used with the secondary accelerator being used in smaller amounts, such as from about 0.05 to about 3 phr, in order to activate and to improve the properties of the vulcanized rubber. Combinations of these accelerators might be expected to produce a synergistic effect on the final properties and are somewhat better than those produced by use of either accelerator alone. In addition, delayed action accelerators may be used which are not affected by normal processing temperatures but produce a satisfactory cure at ordinary vulcanization temperatures. Vulcanization retarders might also be used. Suitable types of accelerators that may be used in the present invention are amines, disulfides, guanidines, thioureas, thiazoles, thiurams, sulfenamides, dithiocarbamates and xanthates. In one embodiment, the primary accelerator is a sulfenamide. If a second accelerator is used, the secondary accelerator may be a guanidine, dithiocarbamate or thiuram compound. Suitable guanidines include dipheynylguanidine and the like. Suitable thiurams include tetramethylthiuram disulfide, tetraethylthiuram disulfide, and tetrabenzylthiuram disulfide.

### II. Rubber Compositions

Representative rubbers that may be used in the rubber compound include acrylonitrile/diene copolymers, natural rubber, halogenated butyl rubber, butyl rubber, cis-1,4-polyisoprene, styrene-butadiene copolymers, cis-1,4-polybutadiene, styrene-isoprene-butadiene terpolymers ethylene-propylene terpolymers, also known as ethylene/propylene/diene monomer (EPDM), and in particular ethylene/propylene/dicyclopentadiene terpolymers. Mixtures of the above rubbers may be used. Each rubber layer may be comprised of the same rubber composition or alternating layers may be of different rubber composition.

The rubber compound may contain a platy filler. Representative examples of platy fillers include talc, clay, mica and mixture thereof. When used, the amount of platy filler ranges from about 25 to 150 parts per 100 parts by weight of rubber (hereinafter referred to as phr). Preferably, the level of platy filler in the rubber compound ranges from about 30 to about 75 phr.

The various rubber compositions may be compounded with conventional rubber compounding ingredients. Conventional ingredients commonly used include carbon black, silica, coupling agents, tackifier resins, processing aids, antioxidants, antiozonants, stearic acid, activators, waxes, oils, sulfur vulcanizing agents and peptizing agents. As known to those skilled in the art, depending on the desired degree of abrasion resistance, and other properties, certain additives mentioned above are commonly used in conventional amounts. Typical additions of carbon black comprise from about 10 to 150 parts by weight of rubber, preferably 50 to 100 phr. Typical amounts of silica range from 10 to 250 parts by weight, preferably 30 to 80 parts by weight and blends of silica and carbon black are also included. Typical amounts of tackifier resins comprise from about 2 to 10 phr. Typical amounts of processing aids comprise 1 to 5 phr. Typical amounts of antioxidants comprise 1 to 10 phr. Typical amounts of antiozonants comprise 1 to 10 phr. Typical amounts of stearic acid comprise 0.50 to about 3 phr. Typical amounts of accelerators comprise 1 to 5 phr. Typical amounts of waxes comprise 1 to 5 phr. Typical amounts of oils comprise 2 to 30 phr. Sulfur vulcanizing agents, such as elemental sulfur, amine disulfides, polymeric polysulfides, sulfur olefin adducts, and mixtures thereof, are used in an amount ranging from about 0.2 to 8 phr. Typical amounts of peptizers comprise from about 0.1 to 1 phr.

### III. Oil

The rubber composition may also include up to 70 phr of processing oil. Processing oil may be included in the rubber composition as extending oil typically used to extend elastomers. Processing oil may also be included in the rubber composition by addition of the oil directly during rubber compounding. The processing oil used may include both extending oil present in the elastomers, and process oil added during compounding. Suitable process oils include various oils as are known in the art, including aromatic, paraffinic, naphthenic, vegetable oils, and low PCA oils, such as MES, TDAE, SRAE and heavy naphthenic oils. Suitable low PCA oils include those having a polycyclic aromatic content of less than 3 percent by weight as determined by the IP346 method. Procedures for the IP346 method may be found in Standard Methods for Analysis & Testing of Petroleum and Related Products and British Standard 2000 Parts, 2003, 62^{nd} edition, published by the Institute of Petroleum, United Kingdom.

Variations in the present inventions are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. An apparatus for applying a mixtures of a first compound and a second compound, the apparatus comprising:
a first extruder and a first gear pump for a first compound;
a second extruder and a second gear pump for a second compound,
a third extruder and a third gear pump for an accelerator mixture;
a mixing device for mixing together said first compound and said second compound and said accelerator mixture, wherein said mixing device is located downstream of said first, second and third extruders and said first, second and third gear pumps.

2. The apparatus of claim 1 further comprising a controller, wherein said controller is in electrical communication with said first, second and third gear pumps and said first, second and third extruders.

3. The apparatus of claim 1 further comprising a pump for pumping oil into said mixing device.

4. The apparatus of claim 1 wherein said mixing device is a static mixer.

5. The apparatus of claim 1 further comprising a fourth gear pump and a fourth extruder.

6. A method of applying a blended rubber composition directly onto a tire building drum or core, the method comprising the steps of:
providing a first extruder and a first gear pump for a first compound;
providing a second extruder and a second gear pump for a second compound,
providing a third extruder and a third gear pump for an accelerator mixture; mixing together said first compound and said second compound and said accelerator mixture, providing a third extruder and a third gear pump downstream of the mixing, and applying one or more strips of the blended rubber composition directly onto the tire building drum or core.
